(19) United States
(12) Patent Application Publication
(10) Pub. No.: US 2025/0180153 A1
(43) Pub. Date: Jun. 5, 2025

(54) METHOD OF FORMING A LONGITUDINAL SLOT IN PRE-INSULATED PIPING

(71) Applicant: GF PIPING SYSTEMS CANADA LTD., Québec (CA)

(72) Inventor: Joseph BAILIE, Spruce Grove (CA)

(21) Appl. No.: 18/834,501

(22) PCT Filed: Mar. 10, 2022
(86) PCT No.: PCT/IB2022/052134

§ 371 Date: Jul. 30, 2024

(51) Int. Cl. F16L 59/14; F16L 59/02

(52) U.S. Cl. CPC F16L 59/14; F16L 59/02

(57) ABSTRACT

A method and apparatus for forming a longitudinal channel in a pre-insulated pipe. The pipe is insulated by spraying a foam as the pipe is being transported in a longitudinal direction while simultaneously being rotated about the pipe's longitudinal axis. The longitudinal channel is formed in the insulation by a cutter that rotates around the perimeter of the pipe while the pipe is being rotated around the pipe's longitudinal axis. The channel houses a heat tracing cable that is subsequently covered with a layer of film and a further layer of foam.

### CROSS-REFERENCE TO RELATED APPLICATIONS

This application is a U.S. National Phase application under 35 U.S.C. 371 of International Application No. PCT/IB2022/052134, filed on Mar. 10, 2022. The entire disclosure of the above application is incorporated herein by reference.

### BACKGROUND

This section provides background information related to the present disclosure which is not necessarily prior art.

### TECHNICAL FIELD

A method and system of inserting a channel into an insulated pipe, comprising:
Providing a medium pipe on a transport line;
Transporting the medium pipe on the transport line, whereby the medium pipe is transported in the longitudinal direction and simultaneously rotated around the longitudinal axis of the pipe;
Applying an insulating foam layer by spraying in a spray booth; and
Inserting a slit-shaped longitudinal channel into the insulating foam layer in a cutting booth with a cutting device.

### Discussion

Insulated pipes are needed in different technical fields. They are used to transport hot and cold medium to reduce the heat exchange. Some insulated pipes are designated to transport hot media. To compensate for heat loss and to maintain a minimum temperature, they have a heat tracing cable along the pipe or section by section, which is arranged between the outer diameter of the medium pipe and the insulating layer.

It is well known that the heat tracing cables will be arranged in factory applied trace conduits, which are arranged in the factory prior to insulating the pipe.

EP 3 587 891 A1 discloses a method for installing a heat trace conduit on a section of a pre-insulated pipe, whereby the heat trace conduit is fixed in a slot in the insulation layer. The disadvantage of this solution is that the process runs discontinuously until the pipe is completed because the pipe has to be repeatedly handled and adjusted to other transport lines.

### SUMMARY

This section provides a general summary of the disclosure and is not a comprehensive disclosure of its full scope or all of its features.

It is one aspect of this invention to propose a method and a system by which an insulated pipe, or several insulated pipes, can be continuously manufactured with an integral longitudinal channel.

This aspect is achieved according to the invention in that that the channel is inserted into the applied foamed insulating layer of the medium pipe by means of a cutting device rotating around the rotating pipe.

This aspect is also achieved according to the inventive system in that a winding unit for wrapping the foam layer having a channel with a layer of film is arranged downstream of the cutting stand too.

The inventive method of inserting a channel into an insulated pipe, comprising the step of providing a medium pipe on a transport line. The transport line transporting the medium pipe in the longitudinal direction and simultaneously rotates the medium pipe around the longitudinal axis of the pipe. The insulating foam layer will be applied on the medium pipe by spraying. Because of the rotation of the pipe the entire circumference is sprayed and the medium pipe is insulated. A slit-shaped longitudinal channel will be inserted into the insulating foam layer. The channel will be inserted over the complete length of the insulated pipe. The channel is inserted into the applied foamed insulating layer of the medium pipe by means of a cutting device rotating around the rotating medium pipe. To bring in a parallel channel to the axis of the pipe it is necessary that the cutting device rotates simultaneously to the pipe which rotates during the complete manufacturing process.

Preferably, after the inserted channel, a layer of film is wound around the foamed layer with the inserted channel. By means of a wound layer of film, the channel is closed on the outside and a closed channel is formed through which the cable can be pulled during installation.

In a preferred embodiment a further foam layer is applied. The second foam layer is sprayed onto the film and forms a further insulation layer. The foam layers are preferably made of PUR (Polyurethane).

Preferably, a protective moisture-sealing plastic layer is extruded over the foam layer as the outermost layer. This layer forms the outer layer of the insulated pipe and is preferably made of HDPE (High Density Polyethylene).

The inventive system for inserting a channel into an insulated pipe, comprise a transport line for transporting the pipe through the system, at least one spray booth for applying the insulating foam layer and a cutting booth with a cutting device, wherein a winding unit for wrapping the foam layer having a channel with a layer of film is arranged downstream of the cutting stand.

Preferably, the transport line includes at least one roller station on which the pipe is rotated and transported in the longitudinal direction. It has been shown to be advantageous if the roller stations are arranged independently of each other between the booths and are distributed at intervals along the length of the transport line. Preferably, the roller station has transport wheels that are arranged at an angle to the pipe axis and thus transport the pipe along the longitudinal axis and rotate it at the same time. Preferably, the pipe is continuously transported and rotated during the entire process.

Preferably, the spray booth is arranged along the transport line, which has a spray device with which the insulating foam is applied to the rotating medium pipe.

Preferably, the cutting booth also arranged along the transport line follows at a distance from the spray booth. During this time, the foam layer can cure and solidify. It has been shown to be advantageous if a roller station is arranged between the spray booth and the cutting booth.

Preferably, the winding unit is also arranged along the transport line and follows the cutting booth.

Preferably, the cutting device is rotatable arranged in the cutting booth around the foamed medium pipe, this allows a simultaneous rotational movement between the pipe and the cutting device and thereby results in a channel running straight parallel to the pipe axis.

Preferably, a further spray booth for applying a further foam layer is arranged downstream of the winding unit. The second spray booth applies a further layer of insulation over the layer of film.

Preferably, the insulation layer is finally covered with an outer layer. For this purpose, it is advantageous if an extrusion device is arranged on the transport line in order to finally extrude a plastic layer over the foam layer.

The object is also achieved according to the invention in that the cutting booth comprising a frame, a drive unit, a planetary gear, wherein the drive unit is driving the planetary gear and a cutting device, wherein that the cutting device is arranged to the planetary gear and rotates around the insulated pipe.

Preferably, the cutting device is attached to a ring gear of the planetary gear. Preferably, the medium pipe with the insulating foam is transported through the ring gear so that the ring gear rotates around the circumference of the pipe, whilst the pipe runs concentrically through the ring gear.

Preferably, the ring gear is supported on rollers which are mounted on the frame of the cutting booth. The rollers are preferably arranged regularly along the circumference of the ring gear.

Preferably the cutting device comprises at least one rotating cutting wheel. The cutting wheel has several preferably fins to cut out the insulation foam to form a channel. As a preferred embodiment the cutting device is designed as a round brush made of wires.

In a preferred embodiment comprises the cutting device a drive unit and a gear unit for driving the cutting wheel. This allows the cutting speed to be adjusted according to the transport speed.

Preferably, the cutting device comprises a cylinder for pressure adjustment. This allows the pressure required to cut the channel to be set.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

An exemplary embodiment of the invention is described by way of the Figures, the invention not being restricted to only the exemplary embodiment, in which:

FIG. 1 shows a view about the inventive system form the top and the side,

FIG. 2 shows the cutting booth from the side,

FIG. 3 shows the cutting booth from the front,

FIG. 4 shows the cutting booth three-dimensional,

FIG. 5 shows the spray booth from the side,

FIG. 6 shows the cutting device three-dimensional,

FIG. 7 shows the cutting device from the top,

FIG. 8 shows the cutting device from the side and

FIG. 9 shows a cross-section from an insulated pipe with a channel.

### DETAILED DESCRIPTION

Example embodiments will now be described more fully with reference to the accompanying drawings.

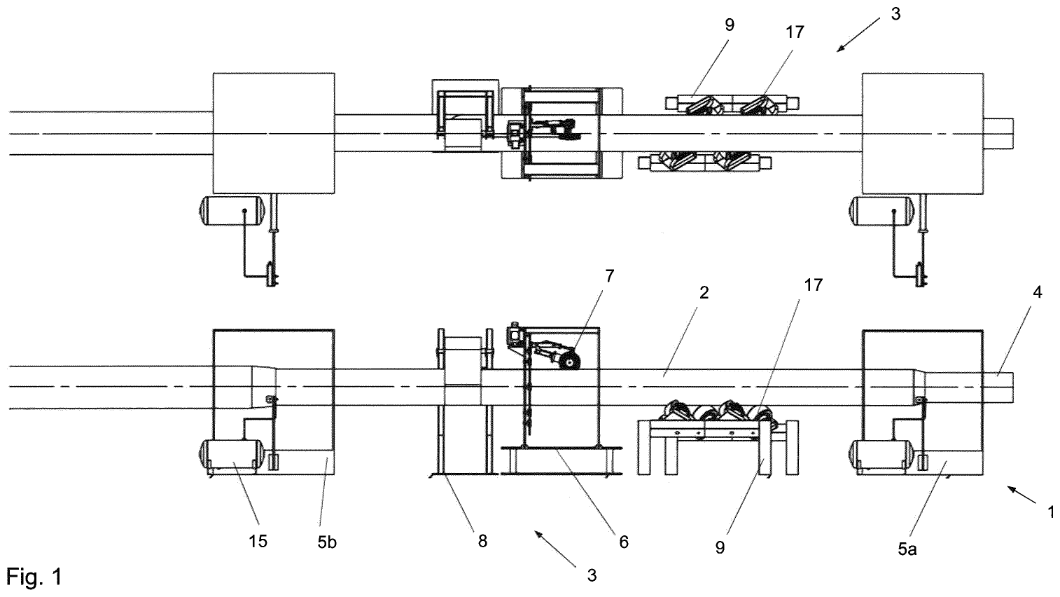

FIG. 1 shows the system 1 according to the invention for a method of inserting a channel 10 into an insulated pipe 2. The pipe is transported in the direction of transport T along the transport line 3. The pipe starts in FIG. 1 on the right of the transport line 3 as a medium pipe 4 and then passes through the spray booth 5a where it is sprayed by the spray device 18 with the insulating foam. During the transport in the transport direction T, the insulated pipe 2 is continuously rotated. For this purpose, a roller station 9 is used, which is located along the transport lines 3 to support the pipe, wherein several roller stations 9 can be arranged along the transport lines 2. The transport wheels 17 are arranged at an angle to the pipe axis which allows the pipe to be transported in transport direction T and rotated at the same time. The pipe is continuously transported and rotated during the entire process. After the spray booth 5a, the pipe, which is coated with the insulation foam around its entire circumference, passes through the cutting booth 6. By means of a cutting device 7, a channel is inserted in longitudinal direction and parallel to the pipe axis. As the pipe rotates over the entire length and during the entire transport, the cutting device 7 rotates simultaneously and thus introduces a linear channel 10 into the inner insulation foam layer 11a. After the cutting boot 6, a layer of film 16 is wrapped around the inner insulation foam layer 11a. This is carried out in the winding unit 8 following the cutting booth 6.

This is preferably followed by a further spray booth 5b which applies a second foamed insulation layer 11b to the wound layer of film 16. Finally, a moisture-sealing plastic outer layer 12 is preferably extruded over the outer foamed insulation layer 11b, whereby the extrusion device is not shown.

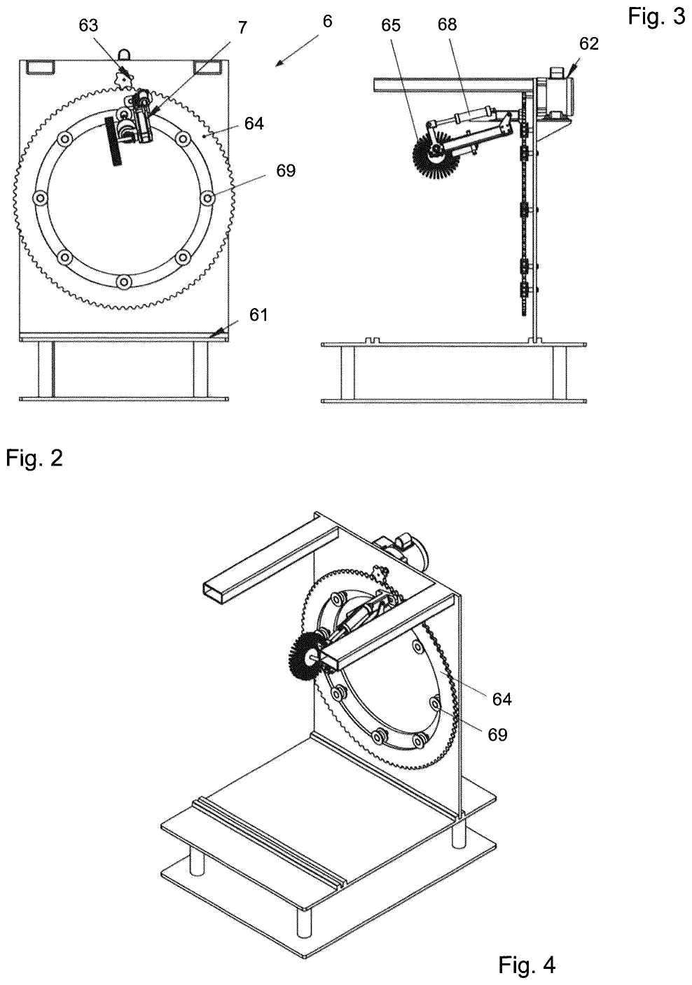

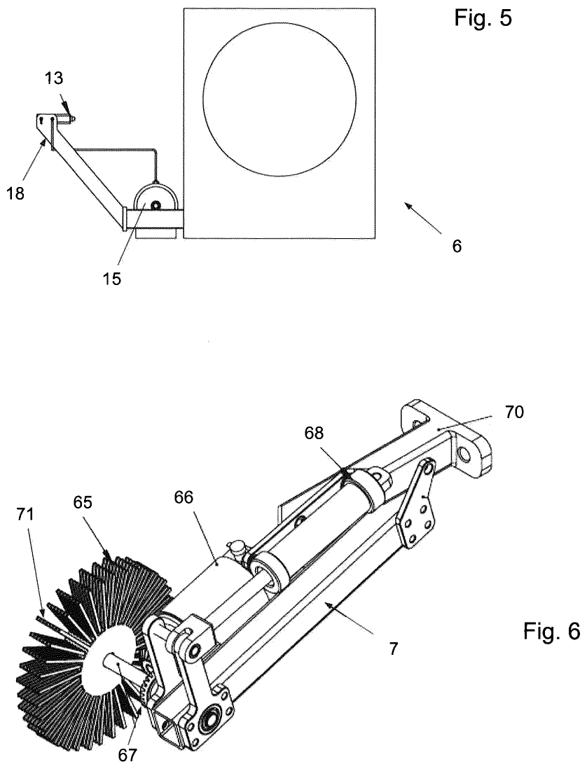

FIGS. 2-4 show the cutting booth 6 in different views. The cutting booth 6 includes a frame 61, a cutting device 7, a drive unit 62, a planetary gear 63. The drive unit 62 drives the planetary gear 63, whereby the ring gear 64 of the planetary gear 63 is mounted on rollers 69, which in turn are arranged on the frame 61. The ring gear 64 rotates simultaneously with the insulated pipe 2 about its axis, which passes through the center of the ring gear 64. The ring gear 64 and the pipe are arranged concentrically to each other. The cutting device 7 is arranged on the ring gear 64 and thus rotates with it, thereby cutting a straight channel in the insulation layer. FIG. 5 schematically shows a spray booth 5a,b with spray hose 18 and a spray nozzle 13 as well as a frame 14 and a spray machine 15 to which the spray nozzle 13 is connected and which the urethane components to be sprayed are proportioned and heated.

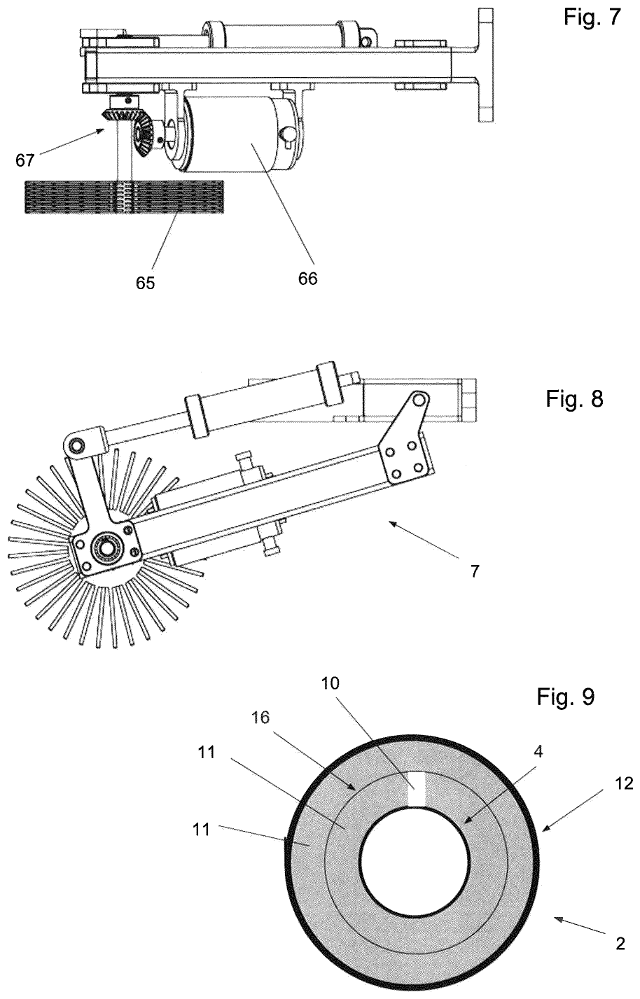

FIGS. 6-8 show the cutting device 7 in different views. The cutting device 7 is arranged on the ring gear 64 with a support 70. It also has one or two cutting wheels 65 that have several fins 71 with which the insulation layer 11 is cut out. The cutting wheel 65 is driven by a drive unit 66, which preferably also has a gear unit 67. In order to adjust the pressure on the insulation foam 11, the cutting device 7 also has a cylinder 68.

FIG. 9 shows a cross-section of an insulated pipe 2 with a inserted channel 10.

The medium pipe 4 as well as the two foam insulation layers 11 and the layer of film 16 arranged in between are clearly visible. Under the layer of film 16 in the first insulation layer, the channel 11 runs parallel to the pipe axis. The outer layer 12 is formed by an extruded plastic layer.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1-12. (canceled)

13. A method of inserting a channel into an insulated pipe, comprising:
Providing a medium pipe on a transport line;
Transporting the medium pipe on the transport line, whereby the medium pipe is transported in the longitudinal direction and simultaneously rotated around the longitudinal axis of the pipe;
Applying an insulating foam layer by spraying; and
Inserting a slit-shaped longitudinal channel into the insulating foam layer, wherein the channel is inserted into the applied foamed insulating layer of the medium pipe by means of a cutting device rotating around the rotating pipe.

14. The method according to claim 13, wherein after the inserted channel, a layer of film is wrapped around the foamed layer with the inserted channel.

15. The method according to claim 13, wherein a further foam layer is applied.

16. The method according to claim 13, wherein a moisture-sealing plastic outer layer is extruded over the foam layer as the outermost layer.

17. A system for inserting a channel into an insulated pipe, comprising a transport line for transporting the pipe through the system, at least one spray booth for applying the insulating foam layer and a cutting booth with a cutting device, wherein a winding unit for wrapping the foam layer having a channel with a layer of film is arranged downstream of the cutting booth.

18. The system according to claim 17, wherein the cutting device is rotatable in the cutting booth about the foam-coated medium pipe.

19. The system according to claim 17, wherein a further spray booth for applying a further foam layer is arranged downstream of the winding unit.

20. A cutting booth in a system for inserting a channel into an insulated pipe preferably according to claim 17, comprising a frame, a drive unit, a planetary gear, wherein the drive unit driving the planetary gear and a cutting device, wherein the cutting device is attached to the planetary gear and rotates around the insulated pipe.

21. The cutting booth according to claim 20, wherein the cutting device is attached to a ring gear of the planetary gear.

22. The cutting booth according to claim 20, wherein the cutting device comprises at least one rotating cutting wheel.

23. The cutting booth according to claim 20, wherein the cutting device comprises a drive unit and a gear unit for driving the cutting wheel.

24. The cutting booth according to claim 20, wherein the cutting device comprises a cylinder for pressure adjustment.
